(19) United States
(12) Patent Application Publication
(10) Pub. No.: US 2024/0051458 A1
(43) Pub. Date: Feb. 15, 2024

(54) METHOD OF INSTALLING AND UNINSTALLING A WARNING INDICATOR DEVICE ON A VEHICLE

(71) Applicant: Kodiak Robotics, Inc., Mountain View, CA (US)

(72) Inventor: Matthew Cearnal, Palmer, TX (US)

(21) Appl. No.: 17/818,430

(22) Filed: Aug. 9, 2022

(51) Int. Cl. B60Q 1/26; B60Q 1/00; B60Q 1/38; B60Q 1/46

(52) U.S. Cl. CPC B60Q 1/2615; B60Q 1/0035; B60Q 1/2607; B60Q 1/381; B60Q 1/46

(57) ABSTRACT

A method of installing a warning indicator device on a vehicle. The method includes mounting the warning indicator device on the vehicle, attaching one or more removable fastening mechanisms to the warning indicator device and the vehicle, and applying a force with the one or more removable fastening mechanisms to secure the warning indicator device to the vehicle. A method of uninstalling a warning indicator device from a vehicle. The method includes loosening one or more removable fastening mechanisms such that a force on the warning indicator device from the one or more removable fastening mechanisms is removed, detaching the one or more removable fastening mechanisms from the warning indicator device, and removing the warning indicator device from the vehicle.

### CROSS REFERENCE TO RELATED APPLICATIONS

The present application is related to U.S. Application Attorney Docket No. 143805.566147, filed Aug. 9, 2022, the entire contents of which are hereby incorporated by reference in its entirety.

### TECHNICAL FIELD

The present disclosure relates to a method of installing and uninstalling a warning indicator device on a vehicle.

### BACKGROUND

Vehicles, such as cars, trucks, motorcycles, or the like, may encounter situations in which the vehicle needs to pull over and stop on a road or on the shoulder of the road. For example, a component of the vehicle may fail or otherwise may stop working, and the vehicle needs to be pulled over out of traffic for safety. When the vehicle stops on the road or the side of the road, the operator of the vehicle may need to notify other road users of the stopped vehicle so as to prevent crashes and accidents.

### BRIEF SUMMARY

A method of installing a warning indicator device on a vehicle. The method comprises mounting the warning indicator device on the vehicle, attaching one or more removable fastening mechanisms to the warning indicator device and the vehicle, and applying a force with the one or more removable fastening mechanisms to secure the warning indicator device to the vehicle.

A method of uninstalling a warning indicator device from a vehicle. The method comprises loosening one or more removable fastening mechanisms such that a force on the warning indicator device from the one or more removable fastening mechanisms is removed, detaching the one or more removable fastening mechanisms from the warning indicator device, and removing the warning indicator device from the vehicle.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 illustrates a schematic, side view of a vehicle including a warning indicator device, according to an embodiment of the present disclosure.

FIG. 2 illustrates a schematic, rear end view of the vehicle of FIG. 1 including a warning indicator device, according to an embodiment of the present disclosure.

FIG. 3 illustrates a schematic perspective view of a removable fastening mechanism for the warning indicator device of FIGS. 1 and 2, according to an embodiment of the present disclosure.

FIG. 4 illustrates a schematic perspective view of a removable fastening mechanism for the warning indicator device of FIGS. 1 and 2, according to another embodiment of the present disclosure.

FIG. 5 is a flow diagram of a method of installing and uninstalling a warning indicator device for a vehicle, according to an embodiment of the present disclosure.

FIG. 6A illustrates a schematic view of exemplary warning indicators on a warning indicator device, according to an embodiment of the present disclosure.

FIG. 6B illustrates a schematic view of exemplary warning indicators on a warning indicator device, according to an embodiment of the present disclosure.

FIG. 6C illustrates a schematic view of exemplary warning indicators on a warning indicator device, according to an embodiment of the present disclosure.

FIG. 6D illustrates a schematic view of exemplary warning indicators on a warning indicator device, according to an embodiment of the present disclosure.

FIG. 6E illustrates a schematic view of exemplary warning indicators on a warning indicator device, according to an embodiment of the present disclosure.

FIG. 6F illustrates a schematic view of exemplary warning indicators on a warning indicator device, according to an embodiment of the present disclosure.

FIG. 6G illustrates a schematic view of exemplary warning indicators on a warning indicator device, according to an embodiment of the present disclosure.

FIG. 6H illustrates a schematic view of exemplary warning indicators on a warning indicator device, according to an embodiment of the present disclosure.

FIG. 7 illustrates a schematic view of exemplary warning indicators on a warning indicator device, according to an embodiment of the present disclosure.

FIG. 8 illustrates a schematic view of exemplary warning indicators on a warning indicator device, according to an embodiment of the present disclosure.

FIG. 9 is a block diagram of a warning indicator device control system, according to an embodiment of the present disclosure.

FIG. 10 is a flow diagram of a method of warning approaching vehicles of an autonomous vehicle, according to an embodiment of the present disclosure.

FIG. 11 is a flow diagram of a method of warning approaching vehicles of an autonomous vehicle, according to another embodiment of the present disclosure.

### DETAILED DESCRIPTION

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first,” “second,”, “third,” etc., may be used interchangeably to distinguish one component from another and are not intended to signify location or importance of the individual components.

The terms “forward” and “rearward” refer to relative positions of a vehicle. For example, forward refers to a position closer to front hood, front bumper, or front fender of the vehicle and rearward refers to a position closer to a rear bumper, rear trunk, or trailer of the vehicle.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The singular forms “a,” “an,” and “the” include plural references unless the context clearly dictates otherwise.

As used herein, “automated,” “autonomous,” or “automatic,” are used to describe functions that are done without user intervention (e.g., by a controller).

When a vehicle stops on the road or the side of the road for various reasons, especially, when the stop may be unexpected, unplanned and/or not a necessary traffic stop (e.g., a routine stop at a traffic light or a stop sign), warning indicators may be required to be provided to notify or alert other road users (e.g., approaching traffic) of the stopped vehicle for safety, for example, to prevent crashes and accidents. For example, the warning indicators signal to the approaching traffic to route around the stopped vehicle. Typically, these warning indicators are provided as warning triangles or warning cones extending on the ground surface behind (e.g., rearward) the vehicle. When a human operator gets out of the vehicle to setup the warning indicators, the human operator may be in danger of being hit or stuck by another vehicle on the road. Further, when the vehicle is an autonomous vehicle (e.g., a vehicle that operates without a human in the vehicle), it is challenging to adequately warn or alert other road users of the stopped vehicle without a human present at the vehicle.

An autonomous vehicle is a vehicle that incorporates vehicular automation and that can sense the environment around the vehicle and can operate with little to no human input. Autonomous vehicles include various sensors to sense the environment. Control systems interpret the sensor information to identify navigation paths and to automatically control the autonomous vehicle. Autonomous vehicles include one or more sensors that gather data and information, communicate with the autonomous vehicle, and may assist in navigating the autonomous vehicle. The one or more sensors may include a plurality of redundant sensors (e.g., multiple sensors of the same type that measure the same type of data). One or more vehicle controllers receive the data and information from the one or more sensors to autonomously control and navigate the autonomous vehicle. For example, the one or more vehicle controllers automatically control one or more control systems (e.g., steering, power, throttle, brakes, etc.) of the autonomous vehicle to control the autonomous vehicle. In some instances, the autonomous vehicle may encounter an emergency such that the autonomous vehicle needs to stop. For example, the one or more vehicle controllers may detect a fault in the one or more sensors, in the one or more control systems, or in the vehicle controllers themselves, or a component on the vehicle may fail or otherwise become damaged. In such instances, the autonomous vehicle can initiate a fallback plan to stop the autonomous vehicle (e.g., either in the current traffic lane or on the shoulder of the road).

In some instances (e.g., when there is an emergency or otherwise), the vehicle may need to stop and alert other vehicles of the stopped vehicle. In such instances, warning indicators need to be configured to notify or alert other road users of the stopped vehicle so as to prevent accidents. When the vehicle is operated by a human operator, such a requirement places the human operator at risk in placing the warning indicators. Further, when the vehicle is operated without a human operator in the vehicle (e.g., the vehicle is an autonomous vehicle), there remains a need for a mechanism or system on the vehicle to configure the warning indicators without a human being present at the vehicle. Accordingly, the present disclosure provides systems and methods for automatically deploying warning devices for an autonomous vehicle.

Accordingly, there remains a need for improved assemblies, systems, and methods for alerting approaching traffic as to a stopped condition of the vehicle. The stopped condition of the vehicle includes an indication that the vehicle is stopped. The stopped condition may also include an indication of a side of the road that that vehicle is stopped, and/or of a side of the vehicle that the approaching traffic is passing or will pass the vehicle. In particular, there remains a need for such improved assemblies, systems, and methods in autonomous vehicles, semi-autonomous vehicles, and/or similar vehicles having no local operator aboard the vehicle. Therefore, as described herein, the embodiments of the present disclosure provide for a warning indicator device mounted or otherwise attached to vehicle to alert approaching traffic and/or approaching persons of the stopped vehicle. The warning indicator device can include one or more warning lights that are configured to display one or more warning indicators. Such warning lights may include, for example, light emitting diodes (LEDs), which can be illuminated to provide indication of the status of the vehicle. Such warning lights may be in lieu of, or in addition to, other warning indicators aboard the vehicle (e.g., the aforementioned warning triangles/cones). A need also exists for a method for activating the warning lights without an onsite/local operator and/or in an autonomous or semi-autonomous process.

The warning indicator device is a light bar (e.g., a bar or similar device having one or more lights thereon). The warning indicator device can be used to create directional lighting patterns. For example, the warning indicators may include directional arrows that are illuminated by turning on the warning lights. The warning indicators may be formed by one or more lights (e.g., LEDs) in a shape of the warning indicators. In commercial vehicles, such as a truck having a tractor unit that tows a trailer (e.g., a tractor trailer), the warning indicator device can be mounted on a rear guardrail of the trailer (e.g., beneath a license plate of the vehicle) such that the warning lights are displayed rearward from the vehicle. The warning indicator device can receive a signal from the vehicle controller onboard the vehicle such that the vehicle can control the warning indicator device.

For trucks, the warning indicator device may be put on each time a trailer is launched, and may be removed after the trailer has landed. To install the warning indicator device onto the vehicle, a user (e.g., a human) may manually connect a removable fastening mechanism to the rear guardrail. For example, the warning indicator device can be connected to the vertical rear guardrails or to the horizontal rear guardrail of the trailer by a band clamp, by a compression clamp, or by any type of clamp or removable fastening mechanism that can apply a force (e.g., tension or compression) to secure the warning indicator device to the vehicle and that can be easily removed from the vehicle. The compression clamp can be reversed to be a tension clamp where the force is generated outward between the warning indicator device and the vertical guardrails. Thus, the warning indicator device can be easily installed and uninstalled from the vehicle, for example, to the trailer whenever a trailer is connected to a tractor unit of the vehicle.

The electronics of the vehicle are connected into the trailer electronics and the vehicle controller can generate signals for turn signals and emergency signal (e.g., hazard lights). The vehicle controller can be programed to include logic or algorithms for controlling the warning indicator device. By using the combination of the emergency signal and the turn signals, the vehicle controller can generate directional lighting to the right, to the left, or to both the right and the left (e.g., if the vehicle stops in the center lane).

The embodiments of the present disclosure provide for warning indicators that do not require a human to be deployed or otherwise setup. In this way, a human does not need to exit their vehicle to deploy warning indicators and/or a human does not otherwise need to be present at the vehicle to configure the warning indicators. Accordingly, the systems and methods of the present disclosure allow warning or alerting approaching vehicles of the stopped vehicle without the need of a human to physically deploy warning indicators.

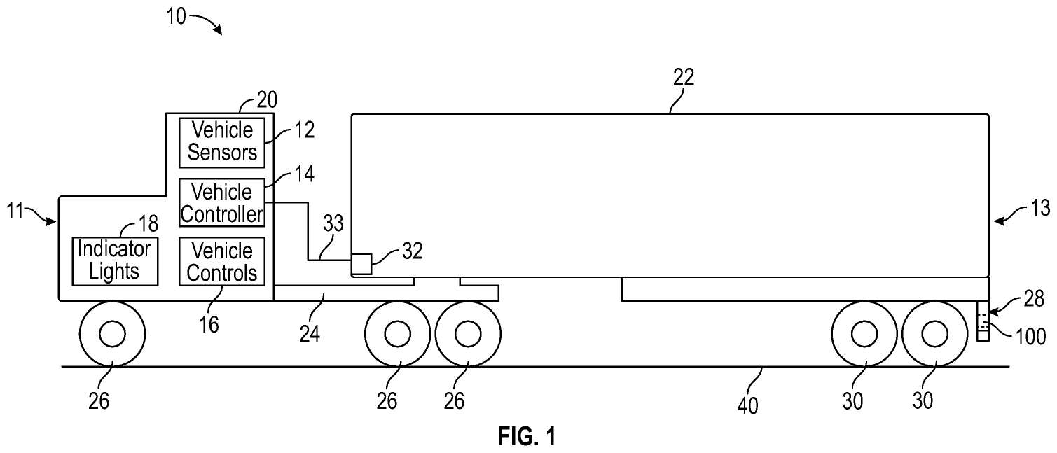

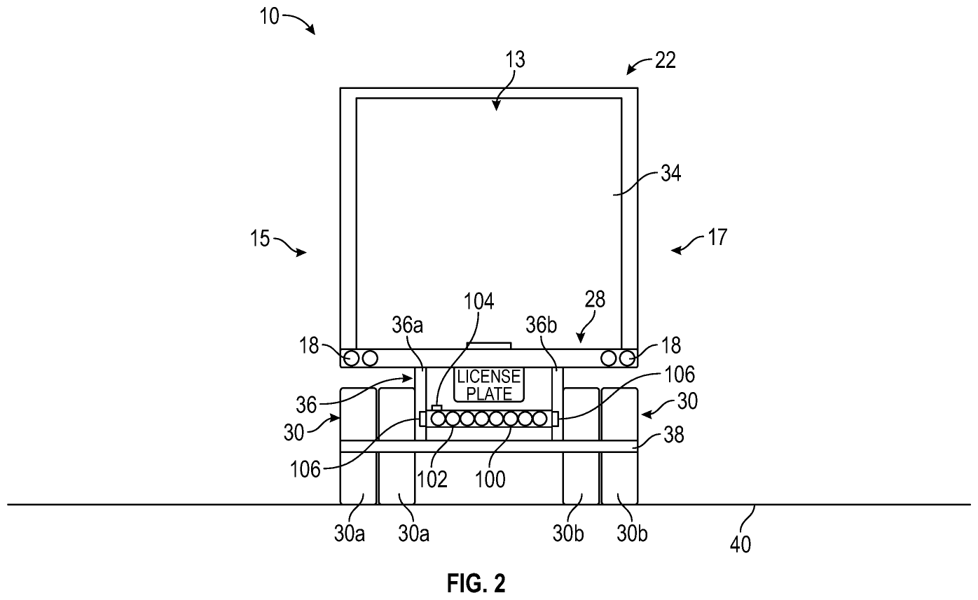

Referring now to the drawings, FIGS. 1 and 2 illustrate a side view and a rear view, respectively, of a vehicle 10 with a warning indicator device 100, according to embodiments of the present disclosure. FIG. 1 shows the warning indicator device 100 is represented schematically by dashed lines and shows a general location of the warning indicator device 100 on the vehicle 10.

FIG. 1 illustrates a schematic, side view of the vehicle 10 including the warning indicator device 100, according to an embodiment of the present disclosure. The vehicle 10 may be any motor vehicle, such as, for example, but not limited to a car, a truck, a commercial truck, a bus, a watercraft (e.g., boat, ship, underwater vehicles, etc.), a motorcycle, an aircraft (e.g., airplane, helicopter, etc.), or any other type of vehicle. For ease of description, the vehicle 10 may be referred to herein as a truck. Further, while reference is made to a vehicle herein, the embodiments of the present disclosure may be used in autonomous vehicles or semi-autonomous vehicles (e.g., vehicles with some human input) and may be used in vehicles that are operated manually by a human operator in the vehicle or remote from the vehicle and have some aspects controlled autonomously. The vehicle 10 includes a forward end 11, also referred to as a forward side, a front side, or a front end, and a rear end 13, also referred to as a rear side, rearward end, or rearward side. The vehicle 10 includes one or more vehicle sensors 12, a vehicle controller 14, vehicle controls 16, and indicator lights 18. When the vehicle 10 is a truck, the vehicle 10 includes a tractor unit 20 that is configured to support and tow a trailer 22, such as a semitrailer. The tractor unit 20 includes a tractor unit frame 24 for supporting the trailer 22 when the trailer 22 is coupled to the tractor unit 20. The tractor unit 20 includes tractor unit wheels 26 that enable the tractor unit 20 to maneuver about a road 40 or other ground surface.

The trailer 22 includes a trailer frame 28 and trailer wheels 30. The trailer 22 also includes a trailer electronics port 32 for receiving one or more cables 33 or like device for supplying power to electronics of the trailer 22. For example, the cables 33 can be coupled to the tractor unit 20 and plugged into the trailer electronics port 32 to supply power from the tractor unit 20 to the trailer 22. The cables 33 can also provide communication from the tractor unit 20 to the trailer 22. For example, the cables 33 can provide communication from the vehicle controller 14 to the trailer 22 such that the vehicle controller 14 can control aspects of the trailer 22 (e.g., control the indicator lights 18, brake lights, or any other aspect of the trailer 22). In some embodiments, the vehicle controller 14 may communicate and control aspects of the trailer 22 wirelessly, as detailed further below.

The indicator lights 18 can include any type of indicator light (e.g., hazard lights or turn signal lights) located anywhere on the vehicle 10. For example, the indicator lights 18 are intermittent flashing indicator lights that flash in unison. The indicator lights 18 are used to indicate an emergency of the vehicle 10 to other vehicle operators or road users.

The vehicle sensors 12 may assist in navigation of the vehicle 10. In some examples, the vehicle sensors 12 may assist in navigation in a manner that results in the vehicle 10 being autonomous, self-driving, semi-autonomous, non-autonomous with assisted navigation, etc., or combinations thereof. In this regard, the vehicle sensors 12 may include components, such as, but not limited to, sensors or other devices, that may be useful for the operation of the vehicle, or any combination thereof. The vehicle 10 may use (via the vehicle controller 14) data collected by the vehicle sensors 12 to navigate or to assist in navigating the vehicle 10 along the road 40 and to control the vehicle controls 16 to control the speed, the direction, the braking, and other functions of the vehicle 10. By way of example, the vehicle sensors 12 may be, or may include the sensors, cameras, and mirrors, described in U.S. Patent Application Publication No. US2022/0144185, the contents of which are herein incorporated by reference in their entirety. The vehicle sensors 12 may take any form and may be located and mounted at any location on the vehicle 10, as desired.

The vehicle sensors 12 include a variety of sensors to monitor the surroundings of the vehicle 10. The sensors may include, for example, but not limited to, one or more cameras, one or more lidars, one or more radars, one or more global positioning systems (GPS), and one or more inertial measurement units (IMUs). The combined data from the sensors may be used by a processor (e.g., the vehicle controller 14) to autonomously (or semi-autonomously) navigate or to assist a driver in navigating the roadway in a variety of light conditions, weather conditions, traffic conditions, load conditions, road conditions, etc. The sensors and the other features of the vehicle sensors 12 are configured and oriented to provide a predetermined field of view and to provide reliable, accurate, and high-quality data for autonomous and semi-autonomous driving. The cameras may include a plurality of cameras including one or more cameras facing the forward end 11, one or more cameras facing the rear end 13, and one or more cameras facing a lateral side perpendicular to the forward end and rear end. In some examples, the cameras may include narrow field of view camera(s), thermal camera(s), wide field of view camera(s), side-facing camera(s), and/or e-mirror camera(s). The aforementioned cameras are merely exemplary, and any number or type of cameras may be included to facilitate the autonomous, semi-autonomous, or assisted navigation of the vehicle 10, including, the cameras described in U.S. Patent Application Publication No. US2022/0144185.

The lidars, the radars, the GPS, the IMUs, and the cameras all provide information and data to autonomously or semi-autonomously operate and navigate the vehicle 10 and/or provide information and data to assist in the navigation of the vehicle 10 where an operator is present inside the cab of the vehicle 10. For example, the lidars may assist in tracking vehicles or objects passing or being passed by the vehicle 10. In an example, the radars may enable the vehicle 10 to navigate in difficult weather and light conditions. The radars may supplement the information from the cameras and from the lidars, which may have difficulty obtaining clear images and signals in the presence of certain weather conditions, such as fog, rain, and snow. The radars may also provide information regarding objects that are occluded in the camera date and the lidar data. In an example, the cameras may track vehicles or objects and assist in tracking of the vehicles or of the objects. The GPS can provide a geolocation of the vehicle 10 and can communicate with other GPS systems to provide geolocations of other vehicles around the vehicle 10. Thus, the vehicle sensors 12 can sense an environment of the vehicle 10 including, for example, objects around the vehicle 10, a road on which the vehicle 10 is operating, curvature of the road, slope of the road, weather conditions, light conditions, and other information regarding the environment about the vehicle 10.

The vehicle controller 14 is in two-way communication with the vehicle sensors 12, the vehicle controls 16, and the indicator lights 18. In this way, the vehicle controller 14 sends and/or receives the data from the vehicle sensors 12 and controls the vehicle controls 16 and/or the indicator lights 18. The vehicle controls 16 include systems for controlling operation of the vehicle 10 to autonomously or semi-autonomously control the vehicle 10. The systems include, for example, an engine, a steering system, a braking system, and other systems that control operation of the vehicle 10. The engine may include any type of engine, for example, an internal combustion engine, an electric motor, a hybrid-electric engine, or other types of power units for propelling, for moving, or for powering the vehicle 10. The vehicle controls 16 include actuators or other devices that control fuel flow, acceleration (e.g., a throttle), steering, braking, or other vehicle controls of the vehicle 10. Thus, the vehicle controller 14 controls the vehicle controls 16 to propel, move, steer, accelerate, and stop the vehicle 10, as detailed further below.

The warning indicator device 100 includes a light bar or similar device having one or more lights therein, as detailed further below. The warning indicator device 100 is mounted to the trailer 22 at the rear end 13 of the vehicle 10. The warning indicator device 100, however, may be located anywhere on the vehicle 10 for displaying the lights rearward of the vehicle 10 to warn other vehicles or road users that the vehicle 10 is stopped. During operation, the vehicle 10 drives or otherwise operates on the road 40 or other driving surface. When the vehicle 10 stops and needs to warn other vehicles that the vehicle 10 is stopped (e.g., the vehicle 10 encounters an emergency), the vehicle controller 14 can control the warning indicator device 100 to turn on the lights during the emergency of the vehicle 10, as detailed further below. Additional features and operation of the warning indicator device 100 are detailed further below.

FIG. 2 illustrates a schematic, rear end 13 view of the vehicle 10 including the warning indicator device 100, according to an embodiment of the present disclosure. The vehicle 10 includes a left side 15 and a right side 17, as defined by the orientation as shown in FIG. 2 when the vehicle 10 is viewed from the rear end 13. The trailer 22 includes a first set of trailer wheels 30a and a second set of trailer wheels 30b. The first set of trailer wheels 30a are on the left side 15 thereof and the second set of trailer wheels 30b are on the right side 17 thereof. The trailer 22 includes one or more trailer doors 34 for providing access to an interior of the trailer 22.

The trailer frame 28 includes one or more vertical rear guardrails 36 that support a horizontal rear guardrail 38 and located at the rear end 13 of the trailer 22. For example, the one or more vertical rear guardrails 36 include a first vertical rear guardrail 36a and a second vertical rear guardrail 36b. The trailer frame 28 can include any number of vertical rear guardrails 36 or horizontal rear guardrails 38 as desired. The horizontal rear guardrail 38 helps to prevent other vehicles from sliding or otherwise moving underneath the trailer 22. The horizontal rear guardrail 38 and/or the vertical rear guardrails 36 can include one or more reflective surfaces (e.g., such as reflective tape or reflective paint) applied thereto to reflect light and notify other road users of the vehicle 10.

The warning indicator device 100 includes one or more warning lights 102. The warning lights 102 may be any size, any shape, and/or configured in any configuration on the warning indicator device 100 as desired. The warning lights 102 may be on a rearward facing side when the warning indicator device 100 is mounted the vehicle 10. Alternatively, or additionally, the warning lights 102 may be presented on an upper side, lower side, lateral side, or any side visible to approaching traffic and/or approaching persons. The warning lights 102 are formed as a series of lights (e.g., lightbulbs), light emitting diodes (LEDs), or the like. The warning lights 102 may be formed within a housing of the warning indicator device 100 and/or may be coupled to an outer surface of the warning indicator device 100. The warning lights 102 may be formed, coupled, or connected to the warning indicator device 100 in any manner that allows visibility by an external person or vehicle. The warning lights 102 may display one or more warning indicators, as detailed further below.

The warning indicator device 100 includes a transmitter 104. The transmitter 104 may be in wireless communication (e.g., WiFi, cellular, satellite, Bluetooth, radio communications, etc.) with the vehicle controller 14. In this way, the vehicle controller 14 is in two-way communication with the warning indicator device 100 to control aspects of the warning indicator device 100 and to receive information from the warning indicator device 100. In some embodiments, the warning indicator device 100 may be connected to the vehicle 10 via a wired connection such that the warning indicator device 100 can receive power and/or communications from the vehicle 10. In some embodiments, the warning indicator device 100 may include one or more batteries or the like for powering the warning indicator device 100. The warning indicator device 100 may receive power and/or communications by any means as desired.

The warning indicator device 100 is coupled to the rear end 13 of the vehicle 10. For example, the warning indicator device 100 can be coupled to the vertical rear guardrails 36 and/or to the horizontal rear guardrail 38, as detailed further below. For example, the warning indicator device 100 can be mounted beneath a license plate of the vehicle 10. The warning indicator device 100 can be mounted such that the warning indicator device 100 extends substantially between the vertical rear guardrails 36. For example, the warning indicator device 100 can extend between the first vertical rear guardrail 36a and the second vertical rear guardrail 36b.

The warning indicator device 100 is coupled to the trailer 22 by one or more removable fastening mechanisms 106. For example, the one or more removable fastening mechanisms 106 secure and attach the warning indicator device 100 to the one or more vertical rear guardrails 36 of the trailer 22. The removable fastening mechanisms 106 can include handles, straps, hooks (e.g., J-hooks), brackets, bolts, or the like, for removably attaching the warning indicator device 100 to the vertical rear guardrails 36. The removable fastening mechanisms 106 applies a force (e.g., compression or tension) to secure the warning indicator device 100 to the vehicle 10 such that the warning indicator device 100 is prevented from slipping or otherwise moving as the vehicle 10 operates. The warning indicator device 100 can be attached to the rear guardrails 36, 38 so as not to interfere or otherwise cover the reflective surfaces of the rear guardrails 36, 38. The warning indicator device 100 can be attached to the vehicle 10 at any location for displaying the warning lights 102 rearward of the vehicle 10 and by any attachment means as desired. The warning indicator device 100 may include any length, width, or height, as desired, for displaying one or more warning lights 102 and for being mounted and secured to the vehicle 10.

The vehicle controller 14 is in two-way communication with the warning indicator device 100 (e.g., via the transmitter 104). The vehicle controller 14 sends control signals to the warning indicator device 100 to control the warning indicator device 100 to turn on and turn off the one or more warning lights 102 and can receive signals from the warning indicator device 100 indicating a status of the warning indicator device 100 (e.g., warning lights 102 are on or off). The vehicle controller 14 can turn on the warning lights 102 in a sequence to warn other vehicles of the vehicle 10, as detailed further below. For example, the warning indicator device 100 can display a light pattern via the warning lights 102 that extends along the warning indicator device 100. The light pattern can indicate a direction for directing traffic (e.g., other vehicles or road users) to the side and/or around the vehicle 10. For example, when the vehicle 10 is stopped in a center lane, the light pattern of the warning lights 102 can alert approaching traffic or road users on both sides (e.g., both the left side 15 and the right side 17) of the vehicle 10. In some embodiments, when the vehicle 10 is stopped on the left side 15 of the road 40 (e.g., on a left shoulder), the light pattern of the warning lights 102 can alert approaching traffic or road users on the right side 17 of the vehicle 10. Likewise, when the vehicle 10 is stopped on the right side 17 of the road 40 (e.g., on a right shoulder), the light pattern of the warning lights 102 can alert approaching traffic or road users on the left side 15 of the vehicle 10.

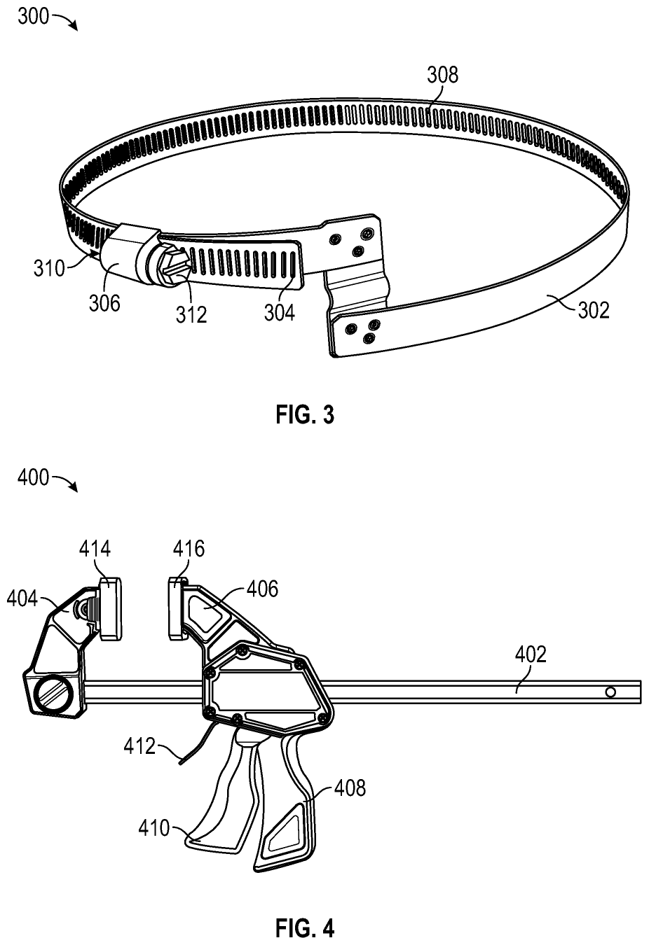

FIG. 3 illustrates a schematic perspective view of a removable fastening mechanism 300 for the warning indicator device 100 (FIGS. 1 and 2), according to an embodiment of the present disclosure. The removable fastening mechanism 300 can be utilized as the removable fastening mechanism 106 of FIG. 2.

The removable fastening mechanism 300 includes a band clamp, such as a worm drive clamp, or the like that comprises an elongated strap 302 that defines a body of the removable fastening mechanism 300. The elongated strap 302 includes a free end 304. The opposite end of the elongated strap 302 has formed thereon a head 306. The elongated strap 302 includes a plurality of ratchet teeth 308 along a length of the elongated strap 302. The plurality of ratchet teeth 308 each extend transversely across the elongate strap 302. The head 306 includes an opening 310 that is sized and shaped to receive the elongate strap 302 therein. The opening 310 includes ratchet teeth (not seen in the view of FIG. 3) that engage with the plurality of ratchet teeth 308 of the elongated strap 302. The head 306 also includes a strap fastening mechanism 312 for applying a force on the elongate strap 302 when the elongate strap 302 is fed through the opening 310 to secure the elongate strap 302 within the head 306.

In operation, a user can mount the warning indicator device 100 (FIG. 2) to the trailer 22 (FIG. 2) between the vertical rear guardrails 36 (FIG. 2). The user can position the removable fastening mechanism 300 such that the elongate strap 302 embraces a portion of the warning indicator device 100 and a portion of a corresponding vertical rear guardrail 36. For example, the user can position a first removable fastening mechanism 300 to the first vertical rear guardrail 36a. The user can feed or otherwise direct the free end 304 of the elongate strap 302 through the opening 310 of the head 306 such that the opening 310 tightly embraces the elongate strap 302. The user can then tighten the strap fastening mechanism 312 to apply a force on the elongate strap 302 in the head 306 to tightly secure the elongate strap 302 in position. When the elongate strap 302 is tightly secured in such a way, the ratchet teeth 308 tightly engage the ratchet teeth of the opening 310 in an interlocking engagement. Thus, the elongate strap 302 is prevented from becoming dislodged or otherwise disengaged from the opening 310. The user can position a second removable fastening mechanism 300 to the second vertical rear guardrail 36b (FIG. 2) in the same manner. In some embodiments, the removable fastening mechanisms 300 can secure the warning indicator device 100 to the horizontal rear guardrail 38. Therefore, the user can tightly secure the warning indicator device 100 to the trailer 22 and the removable fastening mechanism 300 applies a force (e.g., compression) to prevent the warning indicator device 100 from slipping or otherwise moving during operation of the vehicle 10.

FIG. 4 illustrates a schematic perspective view of a removable fastening mechanism 400 for the warning indicator device 100 (FIGS. 1 and 2), according to an embodiment of the present disclosure. The removable fastening mechanism 400 can be utilized as the removable fastening mechanism 106 of FIG. 2.

The removable fastening mechanism 400 includes a trigger clamp or the like that includes a bar 402 defining a bode of the removable fastening mechanism 400. The removable fastening mechanism 400 includes a fixed jaw 404 that is fixedly coupled at a first end of the bar 402. The removable fastening mechanism 400 also includes a movable jaw 406 that is slidably engaged on the bar 402. In this way, the movable jaw 406 can slide or otherwise move along a length of the bar 402. The movable jaw 406 includes a handle 408 having a trigger mechanism 410 and a release mechanism 412. The handle 408 allows a user to hold the removable fastening mechanism 400 in the user's hand and to move the movable jaw 406 along the bar 402. The movable jaw 406 includes a locking mechanism therein (now seen in the view of FIG. 4) that prevents the movable jaw 406 from moving along the bar 402. The locking mechanism is biased to a locked positioned such that the movable jaw 406 does not move. When the release mechanism 412 is actuated, the release mechanism 412 unlocks the locking mechanism such that the movable jaw 406 can be freely moved along the bar 402.

The fixed jaw 404 includes a first pad 414 and the movable jaw 406 includes a second pad 416. The first pad 414 and the second pad 416 are positioned to face each other and to clamp an object between the first pad 414 and the second pad 416. For example, the movable jaw 406 can be moved towards the fixed jaw 404 to clamp an object between the fixed jaw 404 and the movable jaw 406. Actuation of the trigger mechanism 410 moves the movable jaw 406 towards the fixed jaw 404 and allows the removable fastening mechanism 400 to grip the object tightly by applying a force (e.g., compression) on the object. In some embodiments, the fixed jaw 404 and the movable jaw 406 may be rearranged such that the fixed jaw 404 and the movable jaw 406 do not face each other. In such an arrangement, the removable fastening mechanism 400 may apply the force outward to apply tension on the warning indicator device 100 and the vertical rear guardrails 36.

In operation, a user can mount the warning indicator device 100 (FIG. 2) to the trailer 22 (FIG. 2) between the vertical rear guardrails 36 (FIG. 2). The user can position the removable fastening mechanism 400 such that the removable fastening mechanism 400 embraces a portion of the warning indicator device 100 and a portion of a corresponding vertical rear guardrail 36. For example, the user can position a first removable fastening mechanism 400 to the first vertical rear guardrail 36a (FIG. 2). The user can place the first removable fastening mechanism 400 such that the warning indicator device 100 and the first vertical rear guardrail 36a are disposed between the fixed jaw 404 and the movable jaw 406. The user can then actuate the trigger mechanism 410 to move the movable jaw 406 towards the fixed jaw 404 and to apply a force on warning indicator device 100 and the first vertical rear guardrail 36a to tightly secure the warning indicator device 100 to the first vertical rear guardrail 36a. In some embodiments, the movable jaw 406 may move away from the fixed jaw 404 to apply a tension force on the warning indicator device 100 and the vertical rear guardrails 36. The force from the removable fastening mechanism 400 prevents the warning indicator device 100 from slipping or otherwise moving during operation of the vehicle 10. The user can position a second removable fastening mechanism 400 to secure the warning indicator device 100 to the second vertical rear guardrail 36b (FIG. 2) in the same manner. Therefore, the user can tightly secure the warning indicator device 100 to the trailer 22 and the removable fastening mechanisms 400 apply a force to prevent the warning indicator device 100 from slipping or otherwise moving during operation of the vehicle 10.

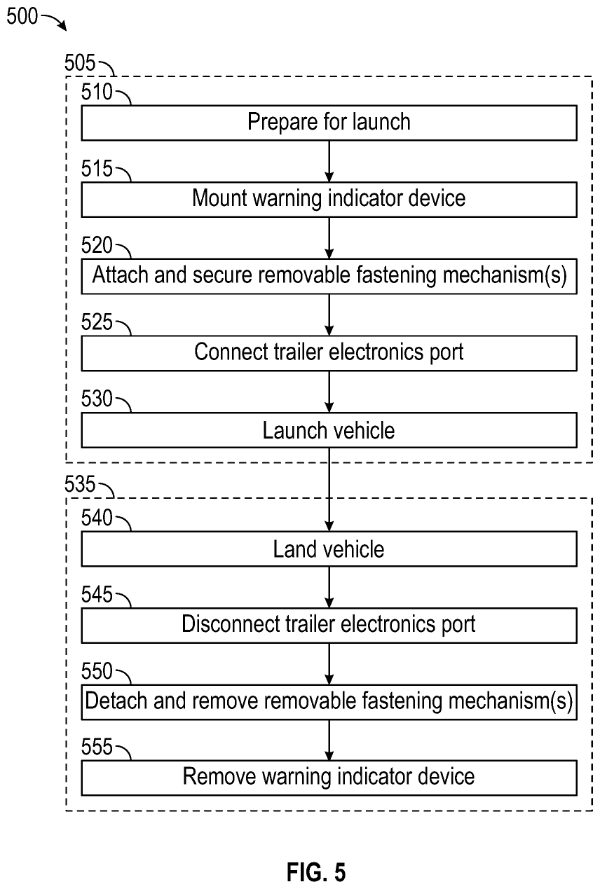

FIG. 5 is a flow diagram of a method 500 of installing (step 505) and uninstalling (step 535) a warning indicator device for a vehicle 10, according to an embodiment of the present disclosure. Reference will be made to the vehicle 10 and the warning indicator device 100 of FIGS. 1 and 2. In step 505, the method 500 includes installing the warning indicator device 100 on the vehicle 10. Installing the warning indicator device 100 comprises steps 510-530 detailed herein. In step 510, the method 500 includes preparing the vehicle 10 for launch. For example, the vehicle 10 can be prepared for launch at a base location, such as at a warehouse or the like. Preparing for launch includes moving the tractor unit 20 into alignment to attach the trailer 22, and a user can attach the trailer 22 to the tractor unit 20. In some examples, the tractor unit 20 can automatically maneuver to align with the trailer 22 and to attach the trailer 22 thereto without user intervention.

In step 515, the method 500 includes mounting the warning indicator device 100 on the vehicle 10. For example, a user can place or otherwise arrange the warning indicator device 100 on the trailer 22 between the vertical rear guardrails 36, as detailed above. In step 520, the method 500 includes attaching and securing the one or more removable fastening mechanisms 106 to secure the warning indicator device 100 to the vehicle 10. For example, the user can place the one or more removable fastening mechanisms 106 about the warning indicator device 100 and the vertical rear guardrails 36 and can apply a force to tighten the removable fastening mechanism 106 such that the force (e.g., compression or tension) is applied to tightly secure the warning indicator device 100 to the vehicle 10, as detailed above. In step 525, the method 500 includes connecting the trailer electronics port 32 to the tractor unit 20. For example, the user can connect the cables 33 to the trailer electronics port 32 such that the trailer 22 can receive power from the tractor unit 20 and communications to and from the vehicle controller 14. In this way, the vehicle controller 14 can control aspects of the trailer 22, such as the indicator lights 18 and the warning indicator device 100. In some embodiments, the warning indicator device 100 can communicate wirelessly with the vehicle controller 14 via the transmitter 104, as detailed above. Thus, the warning indicator device 100 is installed on the vehicle 10.

In step 530, the method 500 includes launching the vehicle 10 to depart the base location. For example, the vehicle 10 can operate autonomously to automatically operate and maneuver about the road 40. In some embodiments, the vehicle 10 is controlled and operated by a human operator in the vehicle 10 or remote from the vehicle 10. As the vehicle 10 is operating, the vehicle 10 may encounter an emergency, or may otherwise need to stop on the road 40 or on a side of the road 40, as detailed above. When the vehicle 10 is stopped, the vehicle controller 14 can control the warning indicator device 100 to turn on the warning lights 102, as detailed further below. When the emergency has been resolved or the warning indicator device 100 is otherwise no longer needed, the vehicle controller 14 can turn off the warning lights 102, and can control the vehicle 10 to operate again. The vehicle 10 can operate and maneuver about the road 40.

When the vehicle 10 completes the current trip, the vehicle 10 can return to the base location. In step 535, the method 500 includes uninstalling the warning indicator device 100 from the vehicle 10. Uninstalling the warning indicator device 100 comprises steps 540-555 detailed herein. In step 540, the method 500 includes landing the vehicle 10. As used herein, “land,” “landed,” or “landing” the vehicle 10 includes returning the vehicle 10 to the base location or to another final destination of the vehicle 10 for a particular trip of the vehicle 10. When the vehicle 10 is landed, the trailer 22 can be disconnected from the tractor unit 20. In step 540, the method 500 includes disconnecting the trailer electronics port 32. For example, the user can disconnect the cables 33 from the trailer electronics port 32 to disconnect the electronics of the trailer 22 from the tractor unit 20. In step 550, the method 500 includes detaching and removing the removable fastening mechanisms 106. For example, the user can loosen the removable fastening mechanisms 106 such that the force (e.g., compression or tension) is removed from the warning indicator device 100. In step 555, the method 500 includes removing the warning indicator device 100 from the vehicle 10. For example, the user can remove the warning indicator device 100. Thus, the warning indicator device 100 is uninstalled from the vehicle 10. The warning indicator device 100 can then be installed onto another vehicle 10, such as onto another trailer 22.

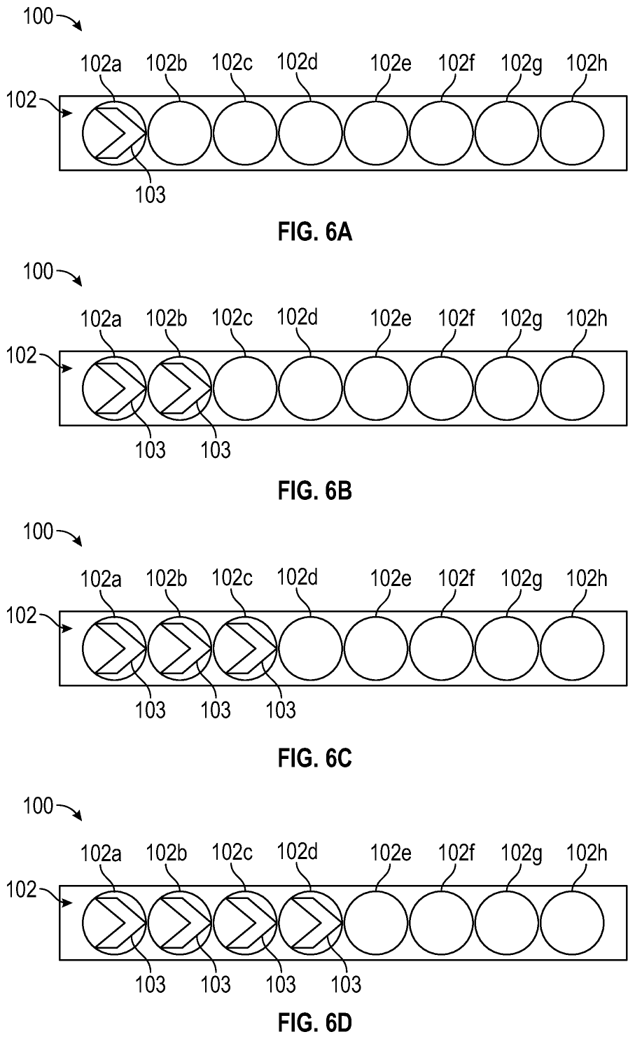

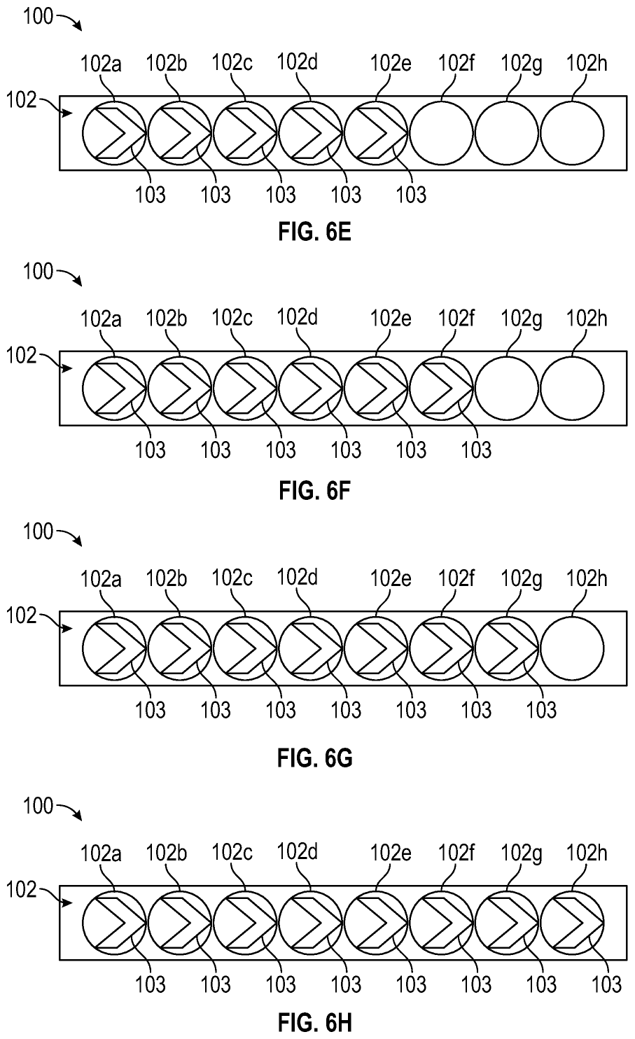

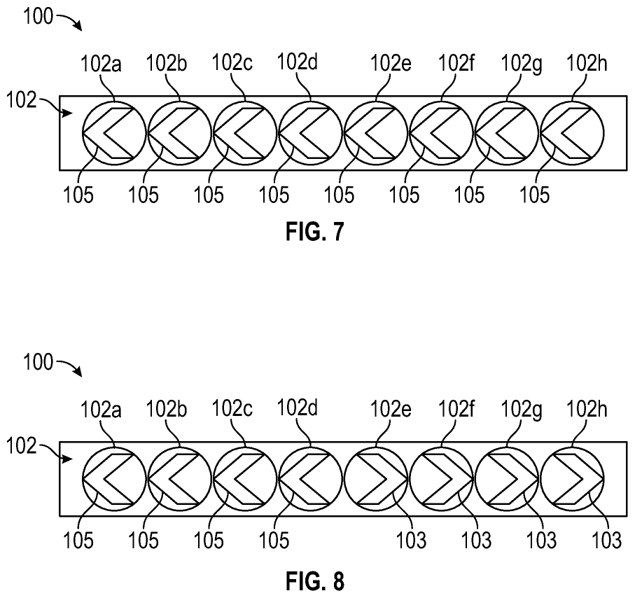

FIGS. 6A to 6H, 7, and 8 represent exemplary configurations of the warning indicator device 100. For clarity, FIGS. 6A to 6H, 7, and 8 do not show the transmitter 104 and the removable fastening mechanisms 106 for the warning indicator device 100. The warning lights 102 may each be formed as a series of lights (e.g., lightbulbs) or LEDs built into the warning indicator device 100. The warning lights 102 may be formed, coupled, or connected to the warning indicator device 100 in any manner that allows for visibility by an external person or vehicle. FIGS. 6A to 6H show the warning indicator device 100 displaying a first warning indicator 103 including a first directional indicator (e.g., a right arrow). In the configuration of FIGS. 6A to 6H, the warning indicator device 100 displays only the first warning indicator 103. FIG. 7 shows the warning indicator device 100 displaying a second warning indicator 105 including a second directional indicator (e.g., a left arrow). The second warning indicator 105 may indicate an opposite direction than the first warning indicator 103. In the configuration of FIG. 7, the warning indicator device 100 displays only the second warning indicator 105. FIG. 8 shows the warning indicator device 100 displaying both the first warning indicator 103 and the second warning indicator 105 pointing away from each other (e.g., in opposite directions). The first warning indicator 103 and the second warning indicator 105 will be detailed further below.

As shown in FIGS. 6A to 6H, the warning lights 102 may have a progressive lighting pattern that continuously repeats when the warning indicator device 100 is activated. For example, the warning lights 102 may begin with a first configuration as shown in FIG. 6A and progress, sequentially, to a last configuration as shown in FIG. 6H. In FIGS. 6A to 6H, the warning indicator device 100 includes eight warning lights 102 including a first warning light 102a, a second warning light 102b, a third warning light 102c, a fourth warning light 102d, a fifth warning light 102e, a sixth warning light 102f, a seventh warning light 102g, and an eighth warning light 102h. When the warning indicator device 100 is mounted on the vehicle 10 (e.g., mounted on the rear end 13), the first warning light 102a may be at a leftmost location of the warning indicator device 100 (e.g., a location nearest the left side 15 of the vehicle 10) and the eighth warning light 102h may be at a rightmost location of the warning indicator device 100 (e.g., a location nearest the right side 17 of the vehicle 10). The warning indicator device 100 may include any number of warning lights 102 formed in any configuration as desired.

Each warning light 102 may display a first warning indicator 103. The first warning indicator 103 is a first symbol that is formed by a configuration of the respective warning light 102. For example, the first warning indicator 103 may be a first directional indicator including a right arrow (e.g., an arrow pointing right) formed by a configuration of the lightbulbs or the LEDs of the respective warning light 102. The warning indicator device 100 turns on the lightbulbs or LEDs that form the first warning indicator 103 to display the first warning indicator 103 on a particular warning light 102. The first warning indicator 103 may be a constant size between the various warning lights 102, limited by the dimensions of each warning light 102. In some embodiments, the first warning indicator 103 may increase in size as the first warning indicator 103 progresses along the warning lights 102, thus increasing the visibility of the first warning indicator 103.

As mentioned, the warning lights 102 may progressively light up from the configuration of FIG. 6A to the configuration of FIG. 6H. For example, the first warning light 102a displays the first warning indicator 103 first (FIG. 6A), the second warning light 102b displays the first warning indicator 103 second (FIG. 6B), the third warning light 102c displays the first warning indicator 103 third (FIG. 6C), the fourth warning light 102d displays the first warning indicator 103 fourth (FIG. 6D), the fifth warning light 102e displays the first warning indicator 103 fifth (FIG. 6E), the sixth warning light 102f displays the first warning indicator 103 sixth (FIG. 6F), the seventh warning light 102g displays the first warning indicator 103 seventh (FIG. 6G), and the eighth warning light 102h displays the first warning indicator 103 eighth (FIG. 6H). When each warning light 102 displays the first warning indicator 103, the warning lights 102 may remain on until the configuration of FIG. 6H is achieved. Once the configuration of FIG. 6H is achieved, the warning lights 102 revert back to the configuration of FIG. 6A (or all turn off) and the progression may continue again. In this manner, the first warning indicator 103 created by the lights or LEDs may continually and progressively light up during the duration of the activation of the warning indicator device 100. In some embodiments, each warning light 102 may flash on and off as the warning indicator device 100 progresses from the configuration of FIG. 6A to the configuration of FIG. 6H. For example, the first warning light 102a may turn on briefly and turn off before, or as, the second warning light 102b turns on. The warning lights 102 may progress this way to the configuration of FIG. 6H.

Although described as progressive, the first warning indicator 103 may be constant (e.g., the configuration of FIG. 6H is constantly and continuously illuminated for the duration of the activation of the warning indicator device 100), the warning indicator device 100 may flash the first warning indicator 103 on and off (e.g., the warning lights 102 flash between all off and all on in the configuration of FIG. 6H), may be flashing between colors (e.g., the warning lights 102 flash between one color in the configuration of FIG. 6H and a second, different color in the configuration of FIG. 6H). The colors in any configuration or lighting effect may be the same or different and may be in any pattern. The lighting effect may be any lighting effect, including, but not limited to, the aforementioned progressive, flashing, and/or constant lighting effects.

FIG. 7 illustrates a schematic view of another exemplary warning indicator on the warning indicator device 100. FIG. 7 shows each warning light 102 may display a second warning indicator 105. The second warning indicator 105 is a second symbol that is formed by a configuration of the respective warning light 102. For example, the second warning indicator 105 may be a second directional indicator including a left arrow (e.g., an arrow pointing left) formed by a configuration of the lightbulbs or the LEDs of the respective warning light 102. The warning indicator device 100 turns on the lightbulbs or LEDs that form the second warning indicator 105 to display the second warning indicator 105 on a particular warning light 102. The second warning indicator 105 may be a constant size between the various warning lights 102, limited by the dimensions of each warning light 102. In some embodiments, the second warning indicator 105 may increase in size as the second warning indicator 105 progresses along the warning lights 102, thus increasing the visibility of the second warning indicator 105.

The warning lights 102 may progressively light up the second warning indicator 105, similar to the first warning indicator 103 detailed above, but opposite of the first warning indicator 103. For example, the warning lights 102 may progressively light up the second warning indicator 105 from the eighth warning light 102h to the first warning light 102a until the configuration of FIG. 7. In this way, the eighth warning light 102h displays the second warning indicator 105 first, the seventh warning light 102g displays the second warning indicator 105 second, the sixth warning light 102f displays the second warning indicator 105 third, the fifth warning light 102e displays the second warning indicator 105 fourth, the fourth warning light 102d displays the second warning indicator 105 fifth, the third warning light 102c displays the second warning indicator 105 sixth, the second warning light 102b displays the second warning indicator 105 seventh, and the first warning light 102a displays the second warning indicator 105 eighth. When each warning light 102 displays the second warning indicator 105, the warning lights 102 may remain on until the configuration of FIG. 7 is achieved. Once the configuration of FIG. 7 is achieved, the warning lights 102 revert back to the first configuration (e.g., all off) and the progression may continue again. In this manner, the second warning indicator 105 created by the lights or LEDs may continually and progressively light up during the duration of the activation of the warning indicator device 100. In some embodiments, each warning light 102 may flash on and off as the warning indicator device 100 progresses to the configuration of FIG. 7. For example, the eighth warning light 102h may turn on briefly and turn off before, or as, the seventh warning light 102g turns on. The warning lights 102 may progress this way to the configuration of FIG. 7.

Although described as progressive, the second warning indicator 105 may be constant (e.g., the configuration of FIG. 7 is constantly and continuously illuminated for the duration of the activation of the warning indicator device 100), the warning indicator device 100 may flash the second warning indicator 105 on and off (e.g., the warning lights 102 flash between all off and all on in the configuration of FIG. 7), may be flashing between colors (e.g., the warning lights 102 flash between one color in the configuration of FIG. 7 and a second, different color in the configuration of FIG. 7). The colors in any configuration or lighting effect may be the same or different and may be in any pattern. The lighting effect may be any lighting effect, including, but not limited to, the aforementioned progressive, flashing, and/or constant lighting effects.

FIG. 8 illustrates a schematic view of exemplary warning indicators on the warning indicator device 100. FIG. 8 shows the warning indicator device 100 may display both the first warning indicator 103 and the second warning indicator 105 simultaneously.

The warning lights 102 may progressively light up the first warning indicator 103 and the second warning indicator 105. For example, the warning lights 102 may progressively light up the first warning indicator 103 and the second warning indicator 105 from a middle location of the warning indicator device 100 (e.g., from the fourth warning light 102d to the first warning light 102a and from the fifth warning light 102e to the eighth warning light 102h) until the configuration of FIG. 8. In this way, the fifth warning light 102e displays the first warning indicator 103 first, the sixth warning light 102f displays the first warning indicator 103 second, the seventh warning light 102g displays the first warning indicator 103 third, and the eighth warning light 102h displays the first warning indicator 103 fourth. Simultaneously, the fourth warning light 102d displays the second warning indicator 105 first, the third warning light 102c displays the second warning indicator 105 second, the second warning light 102b displays the second warning indicator 105 third, and the first warning light 102a displays the second warning indicator 105 fourth. When the respective warning lights 102 display the first warning indicator 103 and the second warning indicator 105, the warning lights 102 may remain on until the configuration of FIG. 8 is achieved. Once the configuration of FIG. 8 is achieved, the warning lights 102 revert back to the first configuration (e.g., all off) and the progression may continue again. In this manner, the first warning indicator 103 and the second warning indicator 105 created by the lights or LEDs may continually and progressively light up during the duration of the activation of the warning indicator device 100. In some embodiments, each warning light 102 may flash on and off as the warning indicator device 100 progresses to the configuration of FIG. 8. For example, the fifth warning light 102e may turn on briefly and turn off before, or as, the sixth warning light 102f turns on, and the fourth warning light 102d may turn on briefly and turn off before, or as, the third warning light 102c turns on. The warning lights 102 may progress this way to the configuration of FIG. 8.

Although described as progressive, the first warning indicator 103 and the second warning indicator 105 may be constant (e.g., the configuration of FIG. 8 is constantly and continuously illuminated for the duration of the activation of the warning indicator device 100), the warning indicator device 100 may flash the first warning indicator 103 and the second warning indicator 105 on and off (e.g., the warning lights 102 flash between all off and all on in the configuration of FIG. 8), may be flashing between colors (e.g., the warning lights 102 flash between one color in the configuration of FIG. 8 and a second, different color in the configuration of FIG. 8). The colors in any configuration or lighting effect may be the same or different and may be in any pattern. The lighting effect may be any lighting effect, including, but not limited to, the aforementioned progressive, flashing, and/or constant lighting effects.

If the vehicle sensors 12 can still actively sense the road environment while the vehicle 10 is stopped or disabled, the pattern of the warning lights 102 may be adjusted based on the information that the vehicle sensors 12 receive. For example, as another vehicle approaches the stopped vehicle 10, the pattern may flash at a higher frequency, may increase the intensity of the light emitted, may change from one flashing pattern design to another flashing pattern design, or may change colors to create an altered indication pattern to further alert the oncoming vehicle of the stopped truck. Such changes to patterns may be progressive as the approaching vehicle gets nearer and nearer to the stopped vehicle 10, or may be changed instantly or near instantly to create a more noticeable change in the pattern. Additionally, multiple changes to the pattern may be implemented as the vehicle approaches. For example, at a first distance, farther away from the vehicle 10, the lighting pattern may be a first color pattern at a first rate of progressive flashing of the warning lights 102. At a second nearer distance, the pattern may increase in frequency and increase in intensity of the light emitted by the warning lights 102. At a third even nearer distance, the intensity and frequency could still be increasing, but the pattern may change from a progressive pattern to an all on/all off flashing pattern and change color. Any combination of changing the signal of the warning lights 102 as a function of the distance to an approaching vehicle may be implemented to increase the opportunity of the approaching vehicle to visibly observe the stopped vehicle 10.

Although the foregoing exemplary warning indicators depict an arrow shape, other shapes and configurations are contemplated, including, for example, one or more triangles (e.g., similar to warning triangles), one or more exclamation points, one or more caret symbols, one or more solid or block arrows, etc. In some embodiments, the warning indicators may be a border of lights around the perimeter of the warning indicator device 100. Thus, the warning indicator may be a lighted outline of the warning indicator device 100 and/or a shape of an arrow. Any of the examples disclosed herein may be combined with other examples. For example, the lighted border and the arrows of any FIGS. 4A to 8 may both be provided on the warning indicator device 100. In this manner, the combination of two lighted patterns may draw additional attention to the warning indicator device 100 thus further alerting approaching traffic and/or persons. Additionally, the arrows may be directed to other directions (e.g., upward, downward, angled, etc.) as opposed to, or in addition, the depicted direction rightward and leftward from the vehicle 10.

In some examples, multiple configurations and multiple patterns may be provided for the warning indicators. For example, a static border of lights and a flashing arrow within the static border of lights.

In some examples, the warning indicators may be a light pattern. In some examples, the warning indicators may be lights, LEDs, an LED panel or screen (e.g., similar to a tablet or computer screen). The warning indicators may be visual indicators not limited to the examples described herein. Additionally, audio indicators may be provided in conjunction with the visual warning indicators to provide additional warning to approaching traffic as to the status of the vehicle 10.

The warning indicators may be present in a manner that alerts approaching persons and/or approaching traffic as to the status of the vehicle 10 (e.g., that the vehicle 10 is stopped). The warning indicators may be a light pattern that extends along the warning indicator device 100.

In some examples, the warning indicators may change configuration when approaching traffic and/or persons are within a predetermined distance from the autonomous vehicle. For example, a predetermined minimum separation distance may be set such that when a vehicle or person is too close to the vehicle 10 (e.g., the predetermined distance is crossed) the lights or LEDs flash at a higher frequency and/or at a higher intensity or brightness, thus increasing the awareness to the approaching person and/or traffic.

Therefore, the warning indicators of the present disclosure provide a light pattern on the warning indicator device 100 located at a rear end 13 of the vehicle 10 (e.g., mounted on the trailer 22) to create an arrow signal directing traffic to the side and/or around the vehicle 10. Providing the warning indicator device 100 to display the warning indicators rearward of the vehicle 10 allows for the vehicle to pullover or stop in the center lane and alert approaching traffic and/or persons on both sides of the vehicle 10. In other examples, when the vehicle is pulled to the left side of the road 40 (e.g., the left shoulder), traffic on the right may be alerted via the first warning indicators 103 on the warning indicator device 100. Likewise, when the vehicle 10 is pulled to the right side of the road 40 (e.g., the right shoulder), traffic on the left may be alerted via the second warning indicators 105 on the warning indicator device 100.

The warning indicators of the present disclosure provide the benefit of alerting approaching traffic and persons as to the stopped vehicle without the need for deployed hardware (such as warning triangles or cones). Accordingly, no additional hardware is required to be attached to the trailer 22, no moving parts that may wear, become stuck, or fail are included, etc.

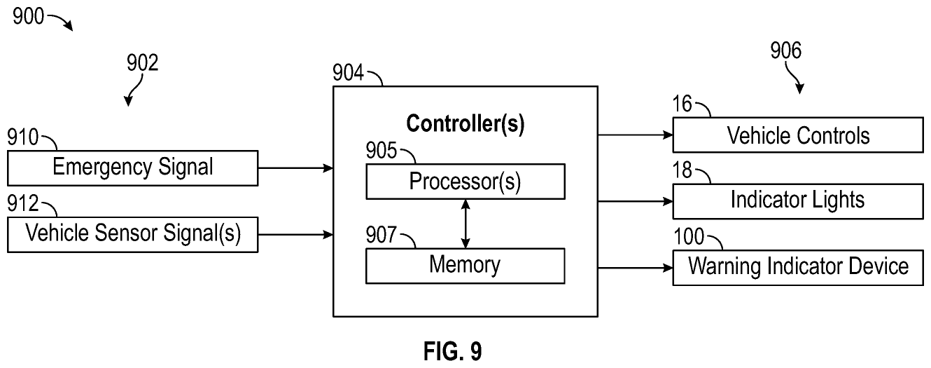

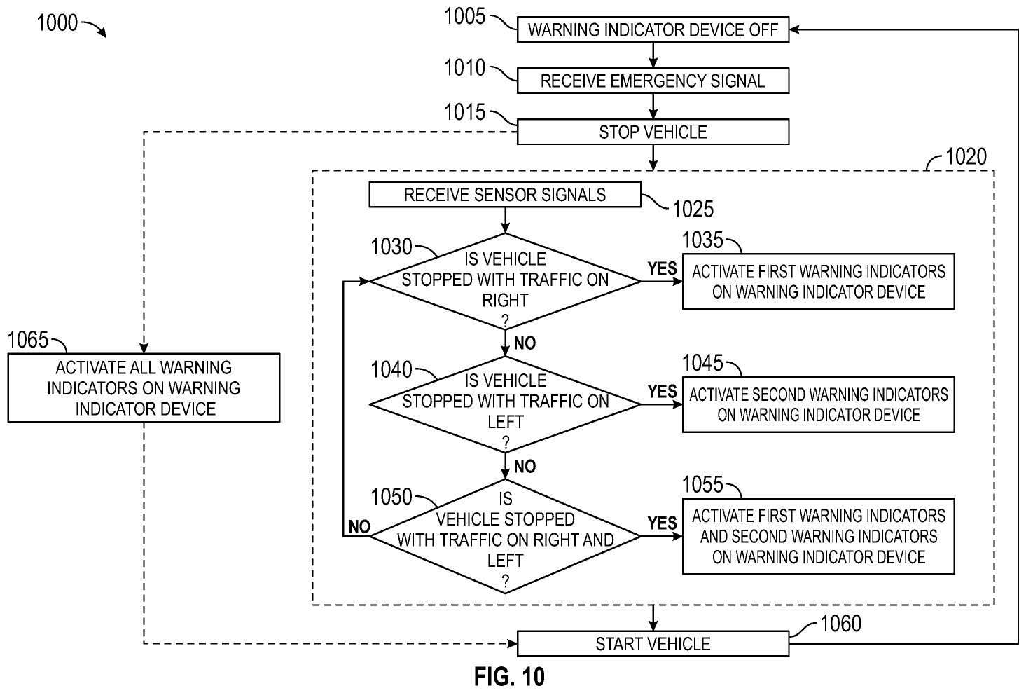

FIG. 9 is a block diagram of a warning indicator device control system 900 for operation and control of at least portions of the vehicle 10, according to an embodiment of the present disclosure. For clarity, reference will be made to the warning indicator device 100 of FIGS. 1, 2, and 6A to 8. The warning indicator device control system 900 includes inputs 902, one or more controllers 904, and outputs 906. The inputs 902 include one or more emergency signals 910 and one or more sensor signals 912 from the vehicle sensors 12. The outputs 906 include the vehicle controls 16, the indicator lights 18, and the warning indicator device 100. The one or more controllers 904 receive the inputs 902, implement a method of warning approaching vehicles of an autonomous vehicle, such as the vehicle 10, and control the outputs 906, as detailed with reference to FIG. 10 below.

The one or more controllers 904 may be one or more standalone controllers, such as the vehicle controller 14. In this embodiment, the one or more controllers 904 include a computing device having one or more processors 905 and a memory 907. The processors 905 can be any suitable processing device, including, but not limited to, a microprocessor, a microcontroller, an integrated circuit, a logic device, a programmable logic controller (PLC), an application specific integrated circuit (ASIC), or a Field Programmable Gate Array (FPGA). The memory 907 can include one or more computer-readable media, including, but not limited to, non-transitory computer-readable media, a computer readable non-volatile medium (e.g., a flash memory), a random access memory (RAM), a read-only memory (ROM), hard drives, flash drives, or other memory devices. A system bus couples the various components including the memory 907 to the processors 905. Portions of the one or more controllers 904 (e.g., portions of the processors 905 and/or the memory 907) may be stored on a network, such as a cloud computing network or the like.

The memory 907 can store information accessible by the processors 905, including computer-readable instructions that can be executed by the processors 905. The instructions can be any set of instructions or a sequence of instructions that, when executed by the processors 905, cause the processors 905 and the controllers 904 to perform operations. The controllers 904 and, more specifically, the processors 905 are programmed or configured to perform these operations, such as the operations discussed further below. In some embodiments, the instructions can be executed by the processors 905 to cause the processors 905 to complete any of the operations and functions for which the controllers 904 are configured, as will be described further below. The instructions can be software written in any suitable programming language or can be implemented in hardware. Additionally, or alternatively, the instructions can be executed in logically or virtually separate threads on the processors 905. The memory 907 can further store data that can be accessed by the processors 905.

To enable user interaction with the one or more controllers 904, an input device represents any number of input mechanisms, such as a microphone for speech, a touch-sensitive screen for gesture or graphical input, keyboard, mouse, motion input, speech and so forth. The input device can be located anywhere (e.g., remote from the vehicle 10 or on the vehicle 10) and may communicate with the one or more controllers 904 by wired or wireless communication. The one or more controllers 904 can communicate with an output device. The output device can be one or more of a number of output mechanisms known to those of skill in the art, such as, for example, a display. In some instances, multimodal systems enable a user to provide multiple types of input to communicate with the one or more controllers 904. A communications interface generally governs and manages the user input and system output. There is no restriction on operating on any particular hardware arrangement and therefore the basic features here may easily be substituted for improved hardware or firmware arrangements as they are developed.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The one or more controllers 904 can include one or more communications interfaces for providing communication with the inputs 902 and the outputs 906. For example, the one or more controllers 904 can communicate with the inputs 902 and the outputs 906 through wired means or through wireless means (e.g., WiFi, cellular, satellite, Bluetooth, radio communications, etc.). In this way, the one or more controllers 904 are communicatively coupled to the vehicle sensors 12, to the vehicle controls 16, to the indicator lights 18, and to the warning indicator device 100.

The emergency signal 910 includes a signal received or otherwise generated by the one or more controllers 904 in response to an emergency detected by the one or more controllers 904. The sensor signals 912 include sensor data from each of the vehicle sensors 12. The vehicle controls 16 output includes actuation of the vehicle controls 16 to control operation and navigation of the vehicle 10. The indicator lights 18 output includes control of the indicator lights 18 to turn the indicator lights 18 on and off. The warning indicator device 100 output includes control of the warning indicator device 100 to turn the warning lights 102 on and off. The one or more controllers 904 receive the inputs 902 and control the outputs 906, as detailed further below.

FIG. 10 is a flow diagram of a method 1000 of warning approaching vehicles of an autonomous vehicle, such as the vehicle 10, according to an embodiment of the present disclosure. Reference will be made to the warning indicator device 100 of FIGS. 1, 2, and 6A to 8 and the warning indicator device control system 900 of FIG. 9. The method 1000 may be performed autonomously or semi-autonomously. That is, upon activation of the vehicle 10, the method 1000 may begin autonomously by the one or more controllers 904. The method 1000 may progress after the warning indicator device 100 has been mounted the vehicle 10, and the vehicle 10 has been launched.

As the vehicle 10 operates and maneuvers about the road 40, in step 1005, the warning indicator device 100 may be turned off. As detailed above, the vehicle 10 may encounter an emergency or may need to otherwise stop on the road 40 or to the side of the road 40. In step 1010, the one or more controllers 904 receive the emergency signal 910 indicating that the vehicle 10 is in an emergency. The emergency can include any type of emergency for the vehicle 10. For example, the emergency can include inconsistencies in sensor readings (e.g., differences between the readings in the redundant sensors), faults in the vehicle controller 14, faults in the vehicle controls 16, faults in the vehicle sensors 12 (e.g., no longer sending or receiving information), or other emergencies or faults in the systems of the vehicle 10 that prevent the vehicle 10 from operating autonomously safely or otherwise from operating safely and that necessitates stopping the vehicle 10. In some examples, the vehicle controller 14 generates the emergency signal 910 in response to detecting a fault in one or more systems, vehicle controls, sensors, or controllers of the vehicle 10.

When the vehicle 10 receives the emergency signal 910, or otherwise needs to stop, in step 1015, the method 1000 includes stopping the vehicle 10. For example, the one or more controllers 904 may control the vehicle controls 16 to stop the vehicle 10. In some embodiments, an operator of the vehicle 10 may control the vehicle controls 16 to stop the vehicle 10. The vehicle 10 can pull over to a left side of the road 40 (e.g., onto a left shoulder or a left lane) such that traffic (e.g., other vehicles) passes the vehicle 10 on the right side 17 of the vehicle 10, to a right side of the road 40 (e.g., onto a right shoulder or a right lane) such that traffic passes the vehicle 10 on the left side 15 of the vehicle 10, or can stop in a center lane of the road 40 such that traffic passes the vehicle 10 on both the left side 15 and the right side 17.

Once the vehicle 10 stops, the method 1000 proceeds to step 1020. In some embodiments, the method 1000 may optionally, or alternatively, proceed to step 1065, as detailed further below. In step 1020, the method 1000 includes activating the warning indicator device 100 according to a predetermined algorithm or program. Within step 1020, the one or more controllers 904 determines where the vehicle 10 is stopped in relation to approaching traffic (where approaching traffic passes the vehicle 10 on the left side 15 of the vehicle 10, passes the vehicle 10 on the right side 17 of the vehicle 10, or passes the vehicle 10 on both the left side 15 and the right side 17). Based on the location of the vehicle with respect to approaching traffic, one or more warning indicators of the warning indicator device 100 are activated. For example, at step 1025, the one or more controllers 904 receive the one or more sensor signals 912 from the one or more vehicle sensors 12. The one or more controllers 904 can determine a stopped condition of the vehicle 10 based on the one or more sensor signals 912. For example, the one or more controllers 904 can determined that the vehicle is stopped. The one or more controllers 904 can also determine a side of the vehicle 10 that the approaching traffic is passing or will be passing, as detailed below with respect to steps 1030, 1040, and 1050. In this way, the stopped condition of the vehicle 10 includes an indication that the vehicle 10 is stopped, an indication of a location of the stopped vehicle 10 on the road 40 (e.g., left side of road, right side of road, or center of road), and/or an indication of a side of the vehicle 10 (e.g., left side 15, right side 17, or both left side 15 and right side 17) that the approaching traffic is passing or will be passing.

In step 1030, the method 1000 includes determining if the vehicle 10 is stopped with traffic on the right side 17 of the vehicle 10. For example, the vehicle 10 can pull over to the left side of the road 40 (e.g., on a left shoulder or left lane) and stop the vehicle 10 such that the traffic passes the vehicle 10 on the right side 17 of the vehicle 10. Based on the one or more sensor signals 912, the one or more controllers 904 determine if vehicle 10 is stopped with traffic on the right side 17 of the vehicle 10. If the vehicle 10 is stopped with traffic on the right side 17 (step 1030: Yes), the method 1000 includes activating the first warning indicator 103 on the warning indicator device 100 (step 1035). For example, the one or more controllers 904 activate the warning lights 102 to activate the first warning indicator 103, as detailed above with respect to FIGS. 6A to 6H.

If the vehicle 10 is stopped and traffic is not on the right side 17 (step 1030: No), the method 1000 includes determining if the vehicle 10 is stopped with traffic on the left side 15 of the vehicle (step 1040). For example, the vehicle 10 can pull over to the right side of the road 40 (e.g., on a right shoulder or right lane) and stop the vehicle 10 such that the traffic passes the vehicle 10 on the left side 15 of the vehicle 10. Based on the one or more sensor signals 912, the one or more controllers 904 determine if vehicle 10 is stopped with traffic on the left side 15 of the vehicle 10. If the vehicle 10 is stopped with traffic on the left side 15 (step 1040: Yes), the method 1000 includes activating the second warning indicator 105 on the warning indicator device 100 (step 1045). For example, the one or more controllers 904 activate the warning lights 102 to activate the second warning indicator 105, as detailed above with respect to FIG. 7.

If the vehicle 10 is stopped and traffic is not only on the right side 17 (step 1030: No) and not only on the left side 15 (step 1040: No), the method 1000 includes determining if the vehicle 10 is stopped with traffic on the right side 17 and on the left side 15 of the vehicle (step 1050). For example, the vehicle 10 can stop in a center lane of the road 40 such that the traffic passes the vehicle 10 on both the right side 17 and the left side 15 of the vehicle 10. Based on the one or more sensor signals 912, the one or more controllers 904 determine if vehicle 10 is stopped with traffic on the right side 17 and the left side 15 of the vehicle 10. If the vehicle 10 is stopped with traffic on the right side 17 and the left side 15 (step 1050: Yes), the method 1000 includes activating the first warning indicator 103 and the second warning indicator 105 on the warning indicator device 100 (step 1055). For example, the one or more controllers 904 activate the warning lights 102 to activate the first warning indicator 103 and the second warning indicator 105, as detailed above with respect to FIG. 8.

The aforementioned step 1020 may be a logic process with the one or more controllers 904 (e.g., the vehicle controller 14) progressively stepping through each of steps 1030, 1040, and 1050 in a yes/no format, if the answer is no to all of the steps (step 1030: No, step 1040: No, step 1050: No), the one or more controllers 904 may repeat the step 1020 for the duration of the stopped time until a vehicle is detected. Alternatively, the step 1020 may occur simultaneously. Alternatively, the step 1020 may be omitted such that any time the vehicle 10 is stopped, one or more or all of the warning indicators are activated for the duration of the stoppage, such as shown at step 1065.

Accordingly, determining the side to warn based on the side of traffic, such as described above, allows for approaching traffic to be alerted to the stopped vehicle 10. In some examples, the method 1000 may simply activate all warning indicators without regard to which side has approaching traffic (step 1065). In some embodiments, as mentioned previously, the warning indicators may simply be activated continuously for the entire duration of the vehicle stoppage, such as shown at step 1065.

When the vehicle 10 is no longer in an emergency (e.g., the emergency has been resolved or mitigated), or the vehicle 10 otherwise no longer needs to activate the warning indicator device 100, the method 1000 includes starting the vehicle 10 (step 1060). Once the vehicle 10 is started at step 1060, the warning indicator device 100 may be deactivated at step 1005. The vehicle 10 may then operate and maneuver on the road 40 again. The one or more controllers 904 may deactivate the warning indicator device 100 at any time, as desired.

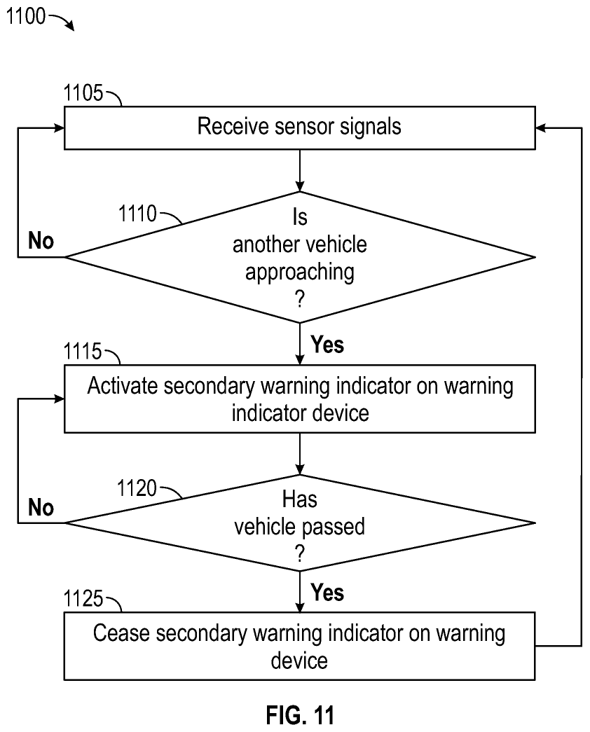

FIG. 11 is a flow diagram of a method 1100 of warning approaching vehicles of an autonomous vehicle, such as the vehicle 10, according to another embodiment of the present disclosure. Reference will be made to the warning indicator device 100 of FIGS. 1, 2, and 6A to 8 and the warning indicator device control system 900 of FIG. 9. The method 1000 may be performed autonomously or semi-autonomously. That is, upon activation of the vehicle 10, the method 1000 may begin autonomously by the one or more controllers 904. The method 1100 may proceed after the vehicle 10 is stopped and after the first warning indicators 103 and/or the second warning indicators 105 have been activated.

In step 1105, the one or more controllers 904 receive the one or more sensor signals 912 from the vehicle sensors 12. The one or more controllers 904 may detect approaching vehicles based on the one or more sensor signals 912. In step 1110, the one or more controllers 904 determine if another vehicle is approaching. If another vehicle is not approaching (step 1110: No), the one or more controllers 904 may continue to receive the one or more sensor signals 912 (step 1105) and determine if another vehicle approaches (step 1110).

If another vehicle is approaching (step 1110: Yes), then the one or more controllers 904 activate a secondary warning indicator (step 1115). The secondary warning indicator may simply be reactivation of a previously on warning indicator, or may be continuous activation of a warning indicator, or may be a new configuration of a warning indicator. In step 1120, the one or more controllers 904 determine if the approaching vehicle is still present or if the approaching vehicle has passed. If the approaching vehicle has not passed the vehicle 10, the one or more controllers 904 continue to activate the secondary warning indicator. If the approaching vehicle has passed the vehicle 10, then the one or more controllers 904 cease activation of the secondary warning indicator (step 1125). The method 1100 may then continue to step 1105 to repeat the method 1100 and to monitor for approaching traffic.

Detecting another vehicle is approaching (step 1110) may also include determining the distance of the approaching vehicle from the vehicle 10. Based upon the distance of the approaching vehicle, the characteristics of the secondary warning system may be changed to create different signal patterns to alert the oncoming vehicle, as previously described above. As the vehicle approaches closer to the stopped vehicle 10, additional, more aggressive warning patterns may be initiated. Once approaching vehicles have passed, the initial warning indicator pattern can be resumed. In such an embodiment, the warning indicator may have a first state and a second state where the change in warning pattern from the first state to the second state is controlled by the distance between the stopped vehicle 10 and the approaching vehicle. The change from one state to the next may be progressive, or may change condition from the first state to the second state based upon a threshold distance. For example, the second state may include at least one of a different pattern of the one or more warning indicators, a different color of the one or more warning indicators, a different size of the one or more warning indicators, a different frequency of the one or more warning indicators, or a different intensity of light emitted by the one or more warning lights with respect to the first state. Additionally, more than two states of the warning indicator may be implemented, so that intermediate distance warning indicators may be initiated.

The aforementioned methods may be autonomous or semi-autonomous. The methods may be activated by the vehicle controller 14, which may be a controller as described in FIG. 9. In some examples, the vehicle sensors 12 may provide information to the vehicle controller 14 to assist in the method 1000 of FIG. 10 and the method 1100 of FIG. 11.

Further aspects of the present disclosure are provided by the subject matter of the following clauses.

A method of installing a warning indicator device on a vehicle. The method comprises mounting the warning indicator device on the vehicle, attaching one or more removable fastening mechanisms to the warning indicator device and the vehicle, and applying a force with the one or more removable fastening mechanisms to secure the warning indicator device to the vehicle.

The method of the preceding clause, wherein mounting the warning indicator device includes mounting the warning indicator device on a trailer of the vehicle.

The method of any preceding clause, wherein mounting the warning indicator device on the trailer includes mounting the warning indicator device to at least one of one or more vertical rear guardrails of the trailer or one or more horizontal rear guardrails of the trailer.

The method of any preceding clause, wherein applying the force includes applying compression on the warning indicator device with the one or more removable fastening mechanisms.

The method of any preceding clause, wherein applying the force includes applying tension on the warning indicator device with the one or more removable fastening mechanisms.

The method of any preceding clause, wherein the one or more removable fastening mechanisms include at least one of a band clamp or a trigger clamp.

The method of any preceding clause, further comprising aligning a tractor unit of the vehicle with a trailer of the vehicle, and connecting the trailer to the tractor unit.

The method of any preceding clause, further comprising connecting a trailer electronics port of the trailer to the tractor unit.

The method of any preceding clause, further comprising launching the vehicle for departure.

The method of any preceding clause, wherein the warning indicator device includes one or more warning lights.

The method of any preceding clause, wherein the one or more warning lights include one or more warning indicators.

The method of any preceding clause, wherein the one or more warning indicators include a first warning indicator including a first directional indicator.

The method of any preceding clause, wherein the one or more warning indicators include a second warning indicator including a second directional indicator.

A method of uninstalling a warning indicator device from a vehicle. The method comprises loosening one or more removable fastening mechanisms such that a force on the warning indicator device from the one or more removable fastening mechanisms is removed, detaching the one or more removable fastening mechanisms from the warning indicator device, and removing the warning indicator device from the vehicle.

The method of any preceding clause, wherein removing the warning indicator device includes removing the warning indicator device from a trailer of the vehicle.

The method of any preceding clause, wherein removing the warning indicator device from the trailer includes removing the warning indicator device from at least one of one or more vertical rear guardrails of the trailer or one or more horizontal rear guardrails of the trailer.

The method of any preceding clause, wherein loosening the one or more removable fastening mechanisms includes removing a compression on the warning indicator device.

The method of any preceding clause, wherein loosening the one or more removable fastening mechanisms includes removing a tension on the warning indicator device.

The method of any preceding clause, wherein the one or more removable fastening mechanisms include at least one of a band clamp or a trigger clamp.

The method of any preceding clause, further comprising disconnecting a trailer of the vehicle from a tractor unit of the vehicle.

The method of any preceding clause, further comprising disconnecting a trailer electronics port of the trailer from the tractor unit.

The method of any preceding clause, further comprising landing the vehicle prior to loosening the one or more removable fastening mechanisms.

The method of any preceding clause, wherein the warning indicator device includes one or more warning lights.

The method of any preceding clause, the one or more warning lights include one or more warning indicators.

The method of any preceding clause, wherein the one or more warning indicators include a first warning indicator including a first directional indicator.

The method of any preceding clause, wherein the one or more warning indicators include a second warning indicator including a second directional indicator.

A method of warning approaching vehicles of an autonomous vehicle. The method comprising receiving one or more sensor signals from one or more vehicle sensors on the autonomous vehicle, determining a stopped condition of the autonomous vehicle based on the one or more sensor signals, and activating one or more warning indicators on a warning indicator device based on the stopped condition, the warning indicator device being mounted on the autonomous vehicle.

The method of the preceding clause, wherein the warning indicator device is mounted on the autonomous vehicle to display the one or more warning indicators rearward of the autonomous vehicle.

The method of any preceding clause, wherein the warning indicator device is mounted on a trailer of the autonomous vehicle.

The method of any preceding clause, wherein the warning indicator device is mounted to at least one of one or more vertical rear guardrails of the trailer or one or more horizontal rear guardrails of the trailer.

The method of any preceding clause, further comprising stopping the autonomous vehicle prior to activating the one or more warning indicators.

The method of any preceding clause, further comprising receiving an emergency signal prior to stopping the autonomous vehicle.

The method of any preceding clause, further comprising determining a location of the approaching vehicles with respect to the autonomous vehicle based on the one or more sensor signals.

The method of any preceding clause, further comprising selectively activating the one or more warning indicators based on the location of the approaching vehicles with respect to the autonomous vehicle.

The method of any preceding clause, further comprising selectively activating one or more first warning indicators of the one or more warning indicators including a first directional indicator if the approaching vehicles are on a first side of the autonomous vehicle.

The method of any preceding clause, wherein the one or more first warning indicators are right directional indicators.

The method of any preceding clause, further comprising selectively activating one or more second warning indicators of the one or more warning indicators including a second directional indicator if the approaching vehicles are on a second side of the autonomous vehicle.

The method of any preceding clause, further comprising selectively activating both the one or more first warning indicators and the one or more second warning indicators if the approaching vehicles are on both the first side and the second side of the autonomous vehicle.

The method of any preceding clause, wherein the one or more second warning indicators are left directional indicators.

The method of any preceding clause, further comprising activating a secondary warning indicator based on the location of the approaching vehicles with respect to the autonomous vehicle.

The method of any preceding clause, wherein the secondary warning indicator includes changing the one or more warning indicators from a first state to a second state.

The method of any preceding clause, wherein the second state includes at least one of a different pattern of the one or more warning indicators, a different color of the one or more warning indicators, a different size of the one or more warning indicators, a different frequency of the one or more warning indicators, or a different intensity of light emitted by the one or more warning indicators with respect to the first state.

The method of any preceding clause, wherein activating the secondary warning indicator comprises activating the second warning indicator based on a distance of the approaching vehicles to the autonomous vehicle.

The method of any preceding clause, wherein the warning indicator device includes a light bar, and the one or more warning indicators include one or more warning lights on the light bar.

The method of any preceding clause, further comprising deactivating the one or more warning indicators.

The method of any preceding clause, wherein activating the one or more warning indicators comprises causing the one or more warning indicators to progressively flash, to flash between on and off, to flash between different colors, to be constantly on, or any combination thereof.

A system for warning approaching vehicles of an autonomous vehicle. The system comprising a warning indicator device mounted on the autonomous vehicle, the warning indicator device comprising one or more warning indicators, one or more vehicle sensors on the autonomous vehicle, and one or more controllers configured to receive one or more sensor signals from the one or more vehicle sensors, determine a stopped condition of the autonomous vehicle based on the one or more sensor signals, and activate the one or more warning indicators on the warning indicator device based on the stopped condition.

The system of the preceding clause, wherein the warning indicator device is mounted on the autonomous vehicle to display the one or more warning indicators rearward of the autonomous vehicle.

The system of any preceding clause, wherein the warning indicator device is mounted on a trailer of the autonomous vehicle.

The system of any preceding clause, wherein the warning indicator device is mounted to at least one of one or more vertical rear guardrails of the trailer or one or more horizontal rear guardrails of the trailer.

The system of any preceding clause, wherein the one or more controllers are configured to stop the autonomous vehicle prior to activating the one or more warning indicators.

The system of any preceding clause, wherein the one or more controllers are configured to receive an emergency signal prior to stopping the autonomous vehicle.

The system of any preceding clause, wherein the one or more controllers are configured to determine a location of the approaching vehicles with respect to the autonomous vehicle based on the one or more sensor signals.

The system of any preceding clause, wherein the one or more controllers are configured to selectively activate the one or more warning indicators based on the location of the approaching vehicles with respect to the autonomous vehicle.

The system of any preceding clause, wherein the one or more controllers are configured to selectively activate one or more first warning indicators of the one or more warning indicators including a first directional indicator if the approaching vehicles are on a first side of the autonomous vehicle.

The system of any preceding clause, wherein the one or more first warning indicators are right directional indicators.

The system of any preceding clause, wherein the one or more controllers are configured to selectively activate one or more second warning indicators of the one or more warning indicators including a second directional indicator if the approaching vehicles are on a second side of the autonomous vehicle.

The system of any preceding clause, wherein the one or more controllers are configured to selectively activate both the one or more first warning indicators and the one or more second warning indicators if the approaching vehicles are on both the first side and the second side of the autonomous vehicle.

The system of any preceding clause, wherein the one or more second warning indicators are left directional indicators.

The system of any preceding clause, wherein the one or more controllers are configured to activate a secondary warning indicator based on the location of the approaching vehicles with respect to the autonomous vehicle.

The system of any preceding clause, wherein the secondary warning indicator includes changing the one or more warning indicators from a first state to a second state.

The system of any preceding clause, wherein the second state includes at least one of a different pattern of the one or more warning indicators, a different color of the one or more warning indicators, a different size of the one or more warning indicators, a different frequency of the one or more warning indicators, or a different intensity of light emitted by the one or more warning indicators with respect to the first state.

The system of any preceding clause, wherein the one or more controllers are configured to activate the secondary warning indicator based on a distance of the approaching vehicles to the autonomous vehicle.

The system of any preceding clause, wherein the warning indicator device includes a light bar, and the one or more warning indicators include one or more warning lights on the light bar.

The system of any preceding clause, wherein the one or more controllers are configured to deactivate the one or more warning indicators.

The system of any preceding clause, wherein the one or more controllers are configured to cause the one or more warning indicators to progressively flash, to flash between on and off, to flash between different colors, to be constantly on, or any combination thereof.

Although the foregoing description is directed to the preferred embodiments, it is noted that other variations and modifications will be apparent to those skilled in the art and may be made without departing from the spirit or scope of the disclosure. Moreover, features described in connection with one embodiment may be used in conjunction with other embodiments, even if not explicitly stated above.

1. A method of installing a warning indicator device on a vehicle, the method comprising:
mounting the warning indicator device on the vehicle;
attaching one or more removable fastening mechanisms to the warning indicator device and the vehicle; and
applying a force with the one or more removable fastening mechanisms to secure the warning indicator device to the vehicle.

2. The method of claim 1, wherein mounting the warning indicator device includes mounting the warning indicator device on a trailer of the vehicle.

3. The method of claim 2, wherein mounting the warning indicator device on the trailer includes mounting the warning indicator device to at least one of one or more vertical rear guardrails of the trailer or one or more horizontal rear guardrails of the trailer.

4. The method of claim 1, wherein applying the force includes applying compression on the warning indicator device with the one or more removable fastening mechanisms.

5. The method of claim 1, wherein applying the force includes applying tension on the warning indicator device with the one or more removable fastening mechanisms.

6. The method of claim 1, wherein the one or more removable fastening mechanisms include at least one of a band clamp or a trigger clamp.

7. The method of claim 1, further comprising aligning a tractor unit of the vehicle with a trailer of the vehicle, and connecting the trailer to the tractor unit.

8. The method of claim 7, further comprising connecting a trailer electronics port of the trailer to the tractor unit.

9. The method of claim 1, further comprising launching the vehicle for departure.

10. The method of claim 1, wherein the warning indicator device includes one or more warning lights.

11. The method of claim 10, wherein the one or more warning lights include one or more warning indicators.

12. The method of claim 11, wherein the one or more warning indicators include a first warning indicator including a first directional indicator.

13. The method of claim 12, wherein the one or more warning indicators include a second warning indicator including a second directional indicator.

14. A method of uninstalling a warning indicator device from a vehicle, the method comprising:
loosening one or more removable fastening mechanisms such that a force on the warning indicator device from the one or more removable fastening mechanisms is removed;
detaching the one or more removable fastening mechanisms from the warning indicator device; and
removing the warning indicator device from the vehicle.

15. The method of claim 14, wherein removing the warning indicator device includes removing the warning indicator device from a trailer of the vehicle.

16. The method of claim 15, wherein removing the warning indicator device from the trailer includes removing the warning indicator device from at least one of one or more vertical rear guardrails of the trailer or one or more horizontal rear guardrails of the trailer.

17. The method of claim 14, wherein loosening the one or more removable fastening mechanisms includes removing a compression on the warning indicator device.

18. The method of claim 14, wherein loosening the one or more removable fastening mechanisms includes removing a tension on the warning indicator device.

19. The method of claim 14, wherein the one or more removable fastening mechanisms include at least one of a band clamp or a trigger clamp.

20. The method of claim 14, further comprising disconnecting a trailer of the vehicle from a tractor unit of the vehicle.

21. The method of claim 20, further comprising disconnecting a trailer electronics port of the trailer from the tractor unit.

22. The method of claim 14, further comprising landing the vehicle prior to loosening the one or more removable fastening mechanisms.

23. The method of claim 14, wherein the warning indicator device includes one or more warning lights.

24. The method of claim 23, the one or more warning lights include one or more warning indicators.

25. The method of claim 24, wherein the one or more warning indicators include a first warning indicator including a first directional indicator.

26. The method of claim 25, wherein the one or more warning indicators include a second warning indicator including a second directional indicator.
